(19) United States
(12) Patent Application Publication
(10) Pub. No.: US 2020/0066457 A1
(43) Pub. Date: Feb. 27, 2020

(54) SELF-FUSED CAPACITOR

(71) Applicant: Apple Inc., Cupertino, CA (US)

(72) Inventors: Ching Yu John Tam, Los Gatos, CA (US); James John Ashe, Saratoga, CA (US); Gang Ning, Santa Clara, CA (US); Won Seop Choi, Pleasanton, CA (US); Meng Chi Lee, Los Altos, CA (US); Parin Patel, San Jose, CA (US); Samuel Benjamin Schaevitz, Los Gatos, CA (US); Derek J. DiCarlo, San Jose, CA (US)

(21) Appl. No.: 16/112,500

(22) Filed: Aug. 24, 2018

(51) Int. Cl. H01G 4/40; H01G 4/005; H01G 4/12; H01G 4/30

(52) U.S. Cl. CPC H01G 4/40; H01G 4/30; H01G 4/12; H01G 4/005

(57) ABSTRACT

Capacitors, including multilayer ceramic capacitors, may be subject to faults and failures that create short circuits between their dielectrics. Capacitors having fuses that protect the capacitors or the electrical devices using the capacitors when such faults occur are described herein. Embodiments include the presence of monolithic and non-monolithic structures including the fuse. Embodiments also include capacitors with multiple fuses that may prevent or mitigate capacitor failure. Methods for manufacturing and using the capacitors are also described.

### BACKGROUND

The present disclosure relates generally to capacitor structures and, more specifically, to capacitor structures with fuse or fuse-like structures that may mitigate or prevent damage due to capacitor failure.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Many electronic devices include electronic circuits that employ capacitors for filtering, impedance matching, energy storage, data storage, and other applications. These electrical devices may use multilayer ceramic capacitors, particularly in applications where the circuit boards have compact dimensions. Due to the plasticity of the material and the high permittivity of the dielectric, the multilayer ceramic capacitors may be produced in very compact and customized dimensions and shapes. These high capacitance capacitors are often used in mission-critical and/or high-value parts of the design of an electronic device. As a result, the capacitor may fail (e.g., not operate as intended), which may occur over time, leading to reduced lifetime of the electronic device. Therefore, methods and systems that improve resilience and prevent or mitigate failure of the capacitors may improve the lifetime of electronic devices.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments described herein include self-fused capacitor devices and structures that may provide protection from or mitigation due to failures of capacitors, as well as methods for use and production thereof. A self-fused capacitor described herein may include one or more fuses in its structure that may break and/or melt upon failure of the capacitor, such as when conductive material or humidity intrudes into a dielectric layer of the capacitor due to for example, thermal effects, physical stress, or environmental of humidity. Such a failure may lead to an increase in electrical current going through the capacitor due to, for example, a short circuit occurring between electrodes in the capacitor. Certain embodiments may include a single fuse in a fuse layer of the capacitor structure that may break upon failure, and may prevent a failed capacitor from decreasing the lifetime of the electronic device. The fuse layer may be a layer in a monolithic structure (e.g., integrated with the capacitor structure) or a separate structure soldered to a capacitor layer forming a non-monolithic capacitor device. Certain embodiments may include multiple fuses associated with electrode layers that may break individually, to mitigate the capacitor failure and allow the capacitor to perform within specifications. Such capacitors may, along with appropriate system design, lead to improved reliability of the electronic devices that may operate in a more fault-tolerant manner.

With the foregoing in mind, in some embodiments, a multilayer ceramic capacitor (MLCC) is described which may include a first group of ceramic layers, with each ceramic layer of this group having a fuse-borne electrode layout. The fuse-borne electrode layout may include two portions formed from a first conductive material, and a fuse link formed from a second conductive material resistively coupling the two portions. The MLCC may also include a second group of ceramic layers, with each ceramic layer of this group having an electrode layout. Adjacent electrodes of the first and the second group may form capacitive couplings.

In one embodiment, a method to produce a capacitor is described. The method may have processes for forming an anode in a first ceramic sheet by applying a first conductive material to two regions of the first ceramic sheet physically separated from each other, and applying a second conductive material to form a fuse link between the two regions. The method may also have processes for forming a cathode in a second ceramic sheet by applying the first conductive material to a second ceramic sheet. The capacitor may be formed by forming a stack that includes the first and second ceramic sheets produced as described.

In one embodiment, a capacitor device is described. The capacitor device may include a first group of electrode layers, each layer having a corresponding electrode coupled to a first termination connector. The capacitor device may include a second group of electrode layers, each layer having a corresponding electrode coupled to a second termination connector. Each electrode from the first group may be capacitively coupled to an adjacent electrode of the second group. The capacitor device may also include a fuse layer that includes a fuse. The fuse may be coupled to the first termination connector and to a first termination of the capacitor device. The fuse may break the resistive coupling between the first termination connector and the first termination when the current carried by the fuse exceeds a threshold current.

### BRIEF DESCRIPTION OF THE DRAWINGS

Various aspects of this disclosure may be better understood upon reading the following detailed description and upon reference to the drawings in which:

FIG. 1 is a diagram of an electrical device that may use the self-fused capacitors described herein, in accordance with an embodiment;

FIG. 2 is a perspective view of a notebook computer that may employ the self-fused capacitors described herein, in accordance with an embodiment;

FIG. 3 is a front view of a hand-held device that may employ the self-fused capacitors described herein, in accordance with an embodiment;

FIG. 4 is a front view of portable tablet computer that may employ the self-fused capacitors described herein, in accordance with an embodiment;

FIG. 5 is a front view of a desktop computer that may employ the self-fused capacitors described herein, in accordance with an embodiment;

FIG. 6 is a front and side view of a wearable electrical device that may employ the self-fused capacitors described herein, in accordance with an embodiment;

FIG. 7 is a schematic electrical diagram of a non-monolithic self-fused capacitor structure, in accordance with an embodiment;

FIG. 8 is a front view of an embodiment of a non-monolithic self-fused capacitor structure, in accordance with an embodiment;

FIG. 9 is a front view of a second embodiment of a non-monolithic self-fused capacitor structure, in accordance with an embodiment;

FIG. 10 is a schematic electrical diagram of a monolithic self-fused capacitor device, in accordance with an embodiment;

FIG. 11 is a front view of an embodiment of a monolithic self-fused capacitor device, in accordance with an embodiment;

FIG. 12 is a flow chart for a method of production of a monolithic self-fused capacitor device, in accordance with an embodiment;

FIG. 13 is a schematic electrical diagram of a monolithic self-fused capacitor with electrode-borne fuses, in accordance with an embodiment;

FIG. 14 is a perspective view of a pair of capacitive electrodes that may include fuses, in accordance with an embodiment;

FIG. 15A is a top view of a capacitive electrode that may include a fuse and may be implemented using a single material, in accordance with an embodiment;

FIG. 15B is a top view of a capacitive electrode that may include a fuse and may be implemented using multiple materials, in accordance with an embodiment;

FIG. 16 is a schematic electrical diagram of a monolithic self-fused capacitor with electrode-borne fuses outside a capacitive region, in accordance with an embodiment;

FIG. 17 is a flow chart for a method of production of a self-fused capacitor with electrode-borne fuses, in accordance with an embodiment; and

FIG. 18 is a flow chart for a method for circuit design that may employ self-fused capacitors for increased reliability, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Many electronic devices may employ capacitors for energy storage, tuning, impedance matching, noise filtering, and other functionalities. Multilayer ceramic capacitors (MLCCs) are capacitors that have advantageous characteristics such as high dielectric permittivity and high material malleability. The use of MLCC technology, thus, allows compact capacitors to have very large capacitances. As a result, MLCC capacitors are often used in mission-critical or high value areas or functions of the electronic devices.

As further detailed below, MLCCs may be assembled by stacking multiple ceramic layers, wherein each layer may have a conductive material stenciled in its surface. The conductive material (e.g., the “metallization”) may form the electrodes of the capacitor, and the ceramic layers between the electrodes may form the dielectric of the capacitor. In certain situations, which may arise due to mechanical stress, thermal stress, humidity, or electrical stress, the ceramic layer may suffer damage, and the dielectric region may suffer a failure that leads to a short circuit between adjacent electrodes of the capacitor. The failure may include, for example, intrusion of the metallization into the dielectric layer due to thermal effects or physical stress, or intrusion of humidity into the dielectric layers. The short circuit may subject the capacitor device to carry excessively large currents (e.g., a current that the capacitor device is not rated for or not intended to operate with, or a current that exceeds a safety margin of a circuit using the capacitor). This effect may cause further deterioration of the dielectric. Moreover, the short-circuit may substantially affect a circuit that includes the capacitor device and cause the electronic device to not operate as intended and/or reduce the lifetime of the electronic device.

Embodiments described herein include capacitor devices and structures that may provide protection or mitigation due to failures such as the one described above. To that end, the described self-fused capacitors may include a fuse or a fuse-like structure that breaks upon a failure that leads to large currents in the capacitor. Certain embodiments include a single fuse that may break upon the occurrence of the failure, and may prevent the failed capacitor from causing damage to the electronic device. Certain embodiments include multiple fuses that may break individually, to mitigate the failure and allow the capacitor to perform within specifications after failure. Such capacitors may, along with appropriate system design, lead to improved reliability of the electronic devices, which may operate in a more fault-tolerant manner.

In the description of the embodiments, different types of electrical couplings (e.g., electrical connections) are discussed. As described herein, resistive couplings and resistive electrical connections may refer to electrical connections that take place through a purely resistive or substantially resistive electrical path, such as the one provided by a short circuit, a resistor, or a wire. Direct couplings and direct electrical connections may refer to resistive couplings that are not mediated by an intermediate device and is generated by direct physical contact or through soldering. Capacitive couplings and capacitive electrical connections may refer to electrical connections that take place through a dielectric capable of storing electrical fields, such as in a coupling between two plates of a capacitor separated by a dielectric.

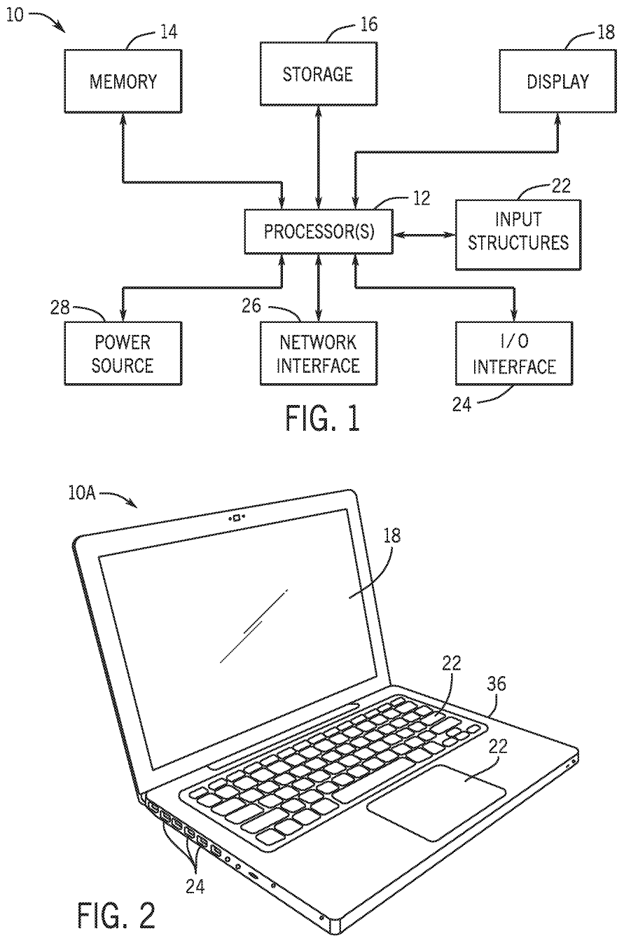

With the foregoing in mind, a general description of suitable electronic devices that may employ a device having self-fused capacitor structures and devices in its circuitry will be provided below. Turning first to FIG. 1, an electronic device 10 according to an embodiment of the present disclosure may include, among other things, one or more processor(s) 12, memory 14, nonvolatile storage 16, a display 18, input structures 22, an input/output (I/O) interface 24, a network interface 26, and a power source 28. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in electronic device 10.

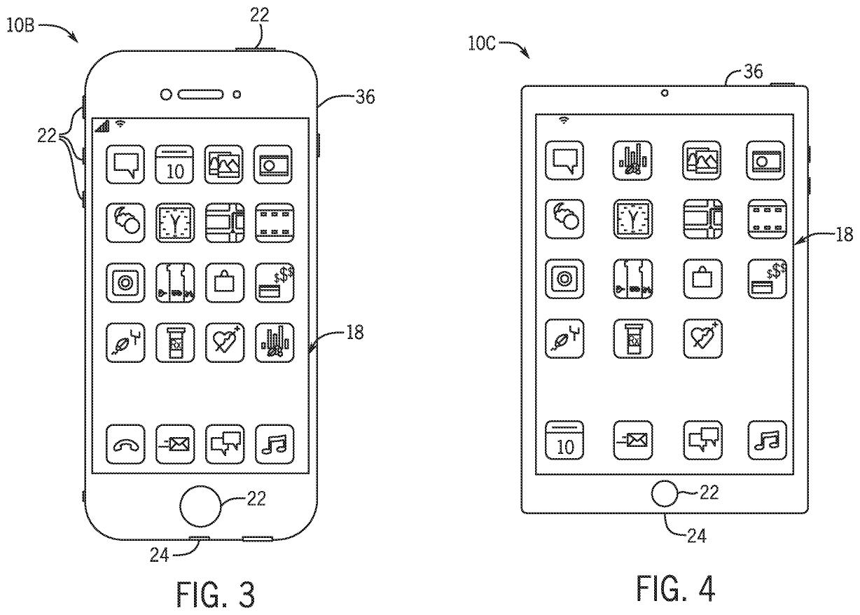

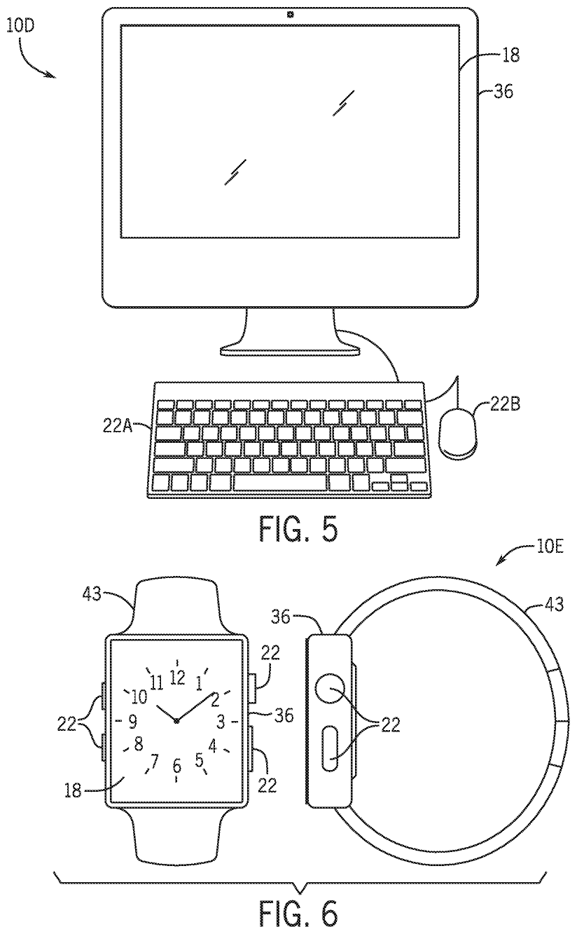

By way of example, the electronic device 10 may represent a block diagram of the notebook computer depicted in FIG. 2, the handheld device depicted in FIG. 3, the handheld device depicted in FIG. 4, the desktop computer depicted in FIG. 5, the wearable electronic device depicted in FIG. 6, or similar devices. It should be noted that the processor(s) 12 and other related items in FIG. 1 may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor(s) 12 may be operably coupled with the memory 14 and the nonvolatile storage 16 to perform various algorithms. Such programs or instructions executed by the processor(s) 12 may be stored in any suitable article of manufacture that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor(s) 12 to enable the electronic device 10 to provide various functionalities.

In certain embodiments, the display 18 may be a liquid crystal display (LCD), which may allow users to view images generated on the electronic device 10. In some embodiments, the display 18 may include a touch screen, which may allow users to interact with a user interface of the electronic device 10. Furthermore, it should be appreciated that, in some embodiments, the display 18 may include one or more organic light emitting diode (OLED) displays, or some combination of LCD panels and OLED panels.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. The network interface 26 may include, for example, one or more interfaces for a personal area network (PAN), such as a Bluetooth network, for a local area network (LAN) or wireless local area network (WLAN), such as an 802.11x Wi-Fi network, and/or for a wide area network (WAN), such as a 3rd generation (3G) cellular network, 4th generation (4G) cellular network, long term evolution (LTE) cellular network, or long term evolution license assisted access (LTE-LAA) cellular network. The network interface 26 may also include one or more interfaces for, for example, broadband fixed wireless access networks (WiMAX), mobile broadband Wireless networks (mobile WiMAX), asynchronous digital subscriber lines (e.g., ADSL, VDSL), digital video broadcasting-terrestrial (DVB-T) and its extension DVB Handheld (DVB-H), ultra-Wideband (UWB), alternating current (AC) power lines, and so forth. Network interfaces 26 such as the one described above may benefit from the use of tuning circuitry, impedance matching circuitry and/or noise filtering circuits that may include self-fused capacitors such as the ones described herein. As further illustrated, the electronic device 10 may include a power source 28. The power source 28 may include any suitable source of power, such as a rechargeable lithium polymer (Li-poly) battery and/or an alternating current (AC) power converter.

In certain embodiments, the electronic device 10 may take the form of a computer, a portable electronic device, a wearable electronic device, or other type of electronic device. Such computers may include computers that are generally portable (such as laptop, notebook, and tablet computers) as well as computers that are generally used in one place (such as conventional desktop computers, workstations, and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 10A, is illustrated in FIG. 2 in accordance with one embodiment of the present disclosure. The depicted computer 10A may include a housing or enclosure 36, a display 18, input structures 22, and ports of an I/O interface 24. In one embodiment, the input structures 22 (such as a keyboard and/or touchpad) may be used to interact with the computer 10A, such as to start, control, or operate a GUI or applications running on computer 10A. For example, a keyboard and/or touchpad may allow a user to navigate a user interface or application interface displayed on display 18.

FIG. 3 depicts a front view of a handheld device 10B, which represents one embodiment of the electronic device 10. The handheld device 10B may represent, for example, a portable phone, a media player, a personal data organizer, a handheld game platform, or any combination of such devices. By way of example, the handheld device 10B may be a model of an iPod® or iPhone® available from Apple Inc. of Cupertino, Calif. The handheld device 10B may include an enclosure 36 to protect interior components from physical damage and to shield them from electromagnetic interference. The enclosure 36 may surround the display 18. The I/O interfaces 24 may open through the enclosure 36 and may include, for example, an I/O port for a hard-wired connection for charging and/or content manipulation using a standard connector and protocol, such as the Lightning connector provided by Apple Inc., a universal serial bus (USB), or other similar connector and protocol.

User input structures 22, in combination with the display 18, may allow a user to control the handheld device 10B. For example, the input structures 22 may activate or deactivate the handheld device 10B, navigate user interface to a home screen, a user-configurable application screen, and/or activate a voice-recognition feature of the handheld device 10B. Other input structures 22 may provide volume control, or may toggle between vibrate and ring modes. The input structures 22 may also include a microphone may obtain a user's voice for various voice-related features, and a speaker may enable audio playback and/or certain phone capabilities. The input structures 22 may also include a headphone input may provide a connection to external speakers and/or headphones.

FIG. 4 depicts a front view of another handheld device 10C, which represents another embodiment of the electronic device 10. The handheld device 10C may represent, for example, a tablet computer, or one of various portable computing devices. By way of example, the handheld device 10C may be a tablet-sized embodiment of the electronic device 10, which may be, for example, a model of an iPad® available from Apple Inc. of Cupertino, Calif.

Turning to FIG. 5, a computer 10D may represent another embodiment of the electronic device 10 of FIG. 1. The computer 10D may be any computer, such as a desktop computer, a server, or a notebook computer, but may also be a standalone media player or video gaming machine. By way of example, the computer 10D may be an iMac®, a MacBook®, or other similar device by Apple Inc. It should be noted that the computer 10D may also represent a personal computer (PC) by another manufacturer. A similar enclosure 36 may be provided to protect and enclose internal components of the computer 10D such as the display 18. In certain embodiments, a user of the computer 10D may interact with the computer 10D using various peripheral input devices, such as the keyboard 22A or mouse 22B (e.g., input structures 22), which may connect to the computer 10D.

Similarly, FIG. 6 depicts a wearable electronic device 10E representing another embodiment of the electronic device 10 of FIG. 1 that may be configured to operate using the techniques described herein. By way of example, the wearable electronic device 10E, which may include a wristband 43, may be an Apple Watch® by Apple, Inc. However, in other embodiments, the wearable electronic device 10E may include any wearable electronic device such as, for example, a wearable exercise monitoring device (e.g., pedometer, accelerometer, heart rate monitor), or other device by another manufacturer. The display 18 of the wearable electronic device 10E may include a touch screen display 18 (e.g., LCD, OLED display, active-matrix organic light emitting diode (AMOLED) display, and so forth), as well as input structures 22, which may allow users to interact with a user interface of the wearable electronic device 10E. The electronic devices 10A, 10B, 10C, 10D, and 10E described above may all employ self-fused capacitors in analog circuitry such as in tuning circuits, impedance matching circuits, power decoupling circuits, filtering circuits, amplifiers, power controllers, and in digital circuitry such as in memory circuitry and digital signal filtering.

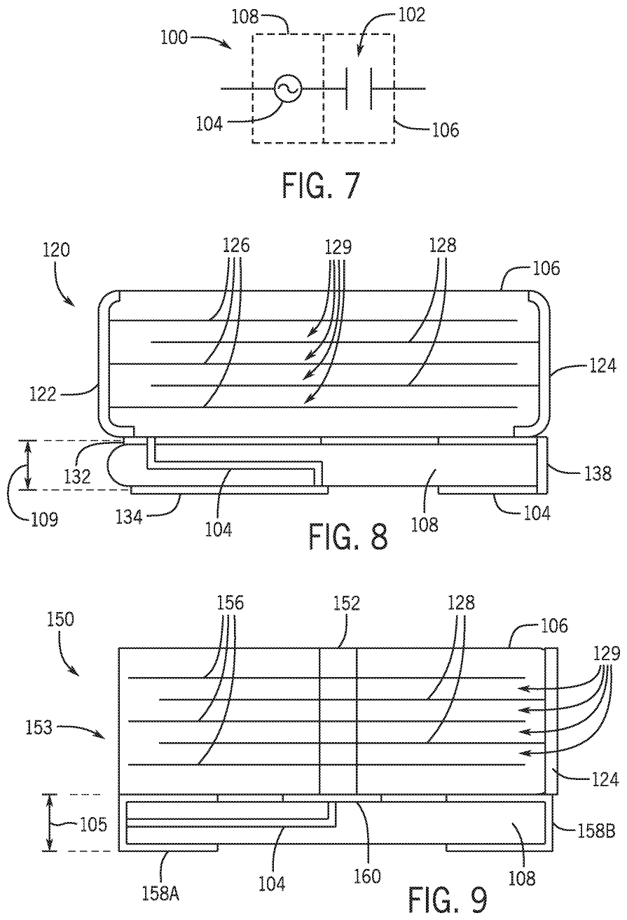

FIG. 7 illustrates a non-monolithic self-fused capacitor structure 100. The capacitor structure 100 may have a capacitor 102 and a fuse 104. In the non-monolithic self-fused capacitor structure 100, the capacitor 102 may be in a capacitor body 106 and the fuse may be in a fuse body 108. The capacitor body 106 may be permanently attached to the fuse body 108 by soldering or some other method for fixing. In some embodiments, the capacitor body 106 may be a MLCC structure. The capacitor body 106 may have terminations that are customized to integrate with the terminations of the fuse body. The fuse body 108 may be a ceramic structure that may employ the same material as the capacitor body, or a different material. The capacitor body 106 or the fuse body 108 may be produced using a low temperature ceramic material or a high temperature ceramic material, such as an aluminum nitrate, aluminum oxide, and/or barium titanate-based ceramic materials. The fuse 104 within the fuse body 108 may be produced using a metal, metal alloy that includes copper, zinc, lead, silver, nickel, aluminum, copper oxide, zinc oxide, lead oxide, silver oxide, nickel oxide, aluminum oxide, and/or the like. The fuse 104 may be placed by direct binding, deposition, or trimming techniques similar to the ones employed in the production of MLCCs.

FIG. 8 illustrates an embodiment of a non-monolithic self-fused capacitor structure 120. The capacitor structure 120 may be formed by the capacitor body 106 and the fuse body 108 (e.g., a fuse layer). The fuse body 108 may have a height 109 between 10 μm and 200 μm. The capacitor body 106 may have a first internal connector 122 and a second internal connector 124 disposed along the ends of the capacitor body 106. The first internal connector 122 may be directly coupled to electrodes 126 and the second internal connector 124 may be directly coupled to electrodes 128. The capacitive couplings between the electrodes 126 and 128 that are formed through the ceramic dielectric 129 of the capacitor body 106 may form the capacitor of the capacitor body 106.

The fuse body 108 may have an internal pad 132 and an external pad 134 that may be used to couple the first internal connector 122 to a printed circuit board. The internal pad 132 and the external pad 134 may be resistively coupled by the fuse 104. The fuse body 108 may also have a second external pad 138 that may be used to couple the second internal connector 124 to the printed circuit board. The internal connectors 122 and 124 may be permanently attached, through soldering or any other suitable method, to the internal pad 132 and the second external pad 138, respectively, forming a direct electrical connection between the capacitor body 106 and the fuse body 108.

Upon a failure in the capacitor structure 120, such as one in which a capacitive coupling between electrodes 126 and 128 becomes a short circuit, the current flowing through the capacitor structure 120 may become excessively large. As a result, the current through the fuse 104 may also become large, causing an increase in temperature in the fuse 104. If the resulting temperature exceeds the melting point of the fuse 104, the fuse 104 may break (i.e., open) and cut the resistive connection between the internal pad 132 and the external pad 134. The capacitor structure 120 becomes, effectively, removed from a circuit including the capacitor structure 120 as a result, and thus prevents or mitigates damage to other devices attached to the printed circuit board and/or the electronic device 10.

FIG. 9 illustrates another embodiment of a non-monolithic self-fused capacitor structure 150. The capacitor structure 150 may be formed by the capacitor body 106 and the fuse body 108 (e.g., a fuse layer). The fuse body 108 may have a height 109 between 10 μm and 200 μm. The capacitor body 106 may have a first internal connector 152 along a middle of the capacitor body 106 and a second internal connector 124 along an end of the capacitor body 106. The end 153 of the capacitor body 106, opposite to the second internal connector 124 does not have a termination metallization in capacitor structure 150. The first internal connector 152 may be coupled to floating electrodes 156 and the second internal connector 124 may be coupled to electrodes 128. The floating electrodes 156 may be referred to as “floating” because they do not extend to an end (e.g., end 153) of the capacitor structure 150, and couple to the first internal connector 152 through, for example, a side of the capacitor body 106. The capacitive couplings between the electrodes 128 and 158 that are formed through the ceramic dielectric 129 of the capacitor body 106 may form the capacitor of the capacitor body 106.

The fuse body 108 in the capacitor structure 150 may have two external pads 158A and 158B and an internal pad 160. In the illustrated example, the external pad 158A is resistively coupled to the internal pad 160 by the fuse 104. The internal pad 160 is directly coupled to the first internal connector 152, and thus, the resistive path that includes the first internal connector 152, internal pad 160, fuse 104, and external pad 158A may couple the floating electrodes 156 to a printed circuit board. The external pad 158B may be used to couple the second internal connector 124 to the printed circuit board, as illustrated. The internal connectors 152 and 124 may be permanently attached, through soldering or any other suitable method, to the internal pad 160 and the second external pad 158B, respectively, forming a direct electrical connection between the capacitor body 106 and the fuse body 108. As with the capacitor structure 120 of FIG. 8, a failure in the capacitor structure 150 that generates a short circuits between any of the floating electrodes 156 and any of the electrodes 128 may cause the fuse 104 to break. As a result, the capacitor structure 150 is effectively removed from a circuit including the capacitor structure 150, and thus prevents or mitigates damage to other devices attached to the printed circuit board and/or the electrical device 10.

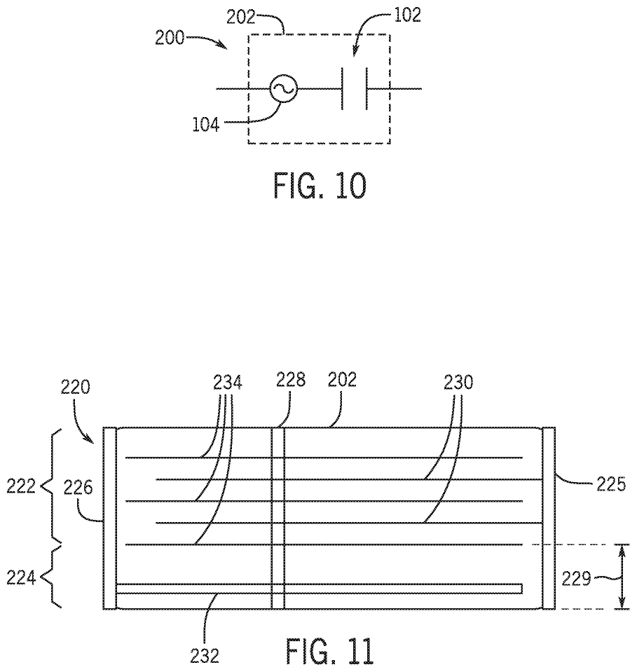

FIG. 10 illustrates a monolithic self-fused capacitor structure 200. The capacitor structure 200 may have a capacitor 102 and a fuse 104. In the monolithic self-fused capacitor structure 200, the capacitor 102 and the fuse 104 are in a same device body 202. In some embodiments, the device body 202 may be formed using multilayer ceramic techniques, as detailed below. The device body 202 may be produced using a low temperature ceramic material or a high temperature ceramic material, such as an aluminum nitrate, aluminum oxide, barium titanate-based ceramic materials, and/or the like.

FIG. 11 illustrates an embodiment of a monolithic self-fused capacitor structure 220. The capacitor structure 220 may have a device body 202 which may have a capacitive layer 222 and a fuse layer 224. The fuse layer 224 may have a height 229 (e.g., a thickness) that may be between 10 μm and 200 μm. The capacitor structure 220 may have a first termination 225 and a second termination 226, which are intended to couple to an external device (e.g., a printed circuit board). The capacitor structure 220 may also have an internal connector 228 that is not intended to couple to an external device, and may be internal to the capacitor structure 220 (e.g., not exposed on the outside of the device body 202). The capacitive layer 222 may have electrodes 230 that are coupled to the first termination 225. The capacitive layer 222 may also have the floating electrodes 234, which may be capacitively coupled to the electrodes 230.

The floating electrodes 234 may be resistively coupled to a fuse 232 in the fuse layer 224 via the internal connector 228. The internal connector 228 may be coupled to the second termination 226. In the illustrated capacitor structure 220, floating electrodes 234 are connected to the second termination 226 via the fuse 232, and are not directly connected to the second termination 226. Upon a failure in the capacitor structure 220 that may result in a short circuit, such as when a capacitive coupling between electrodes 230 and 234 short or become resistive, the current flowing through the capacitor structure 220 and, thus, through the fuse 232 may become excessively large. The temperature of the fuse 232 may increase due to the large current and, when the resulting temperature reaches, approaches, or exceeds the melting point of the fuse 232, the fuse 232 may break. The broken fuse 232 may prevent electrical coupling between the floating electrodes 234 and the printed circuit board and, as a result, the capacitor structure 220 becomes effectively removed from a circuit including the capacitor structure 220.

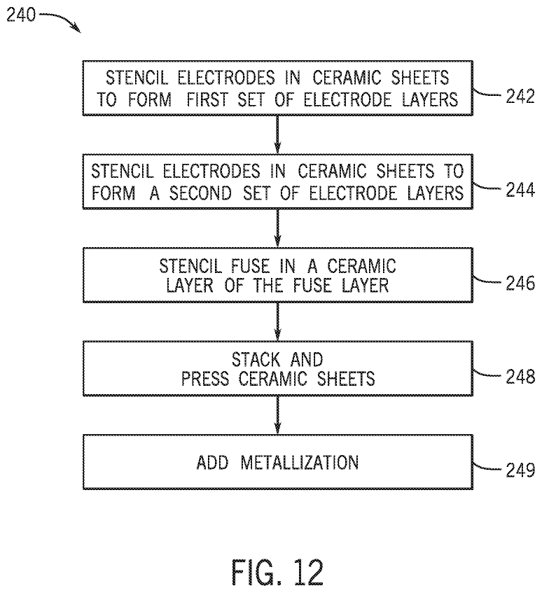

FIG. 12 is a flow chart of a method 240 that may be used to produce a monolithic self-fused capacitor, such as the capacitor structure 220 illustrated in FIG. 11 above. In process block 242, a first group of ceramic sheets may be stenciled with a conductive material to create electrode layers of a first group (e.g., cathode layers). In process block 242, a second group of ceramic sheets may be stenciled with the conductive material to create electrode layers of a second group (e.g., anode layers). The electrodes may be stenciled using nickel or a nickel oxide, or any other suitable material to produce MLCC layers. The stenciling in process block 242 may include deposition, direct binding, and/or trimming.

In process block 246, a ceramic sheet may be stenciled with a conductive material to create a fuse ceramic sheet. The fuse may be stenciled using an alloy that includes copper, zinc, lead, silver, nickel, aluminum, copper oxide, zinc oxide, lead oxide, silver oxide, nickel oxide, aluminum oxide, and/or the like. The stenciling in process block 246 may include deposition, direct binding, and/or trimming. The fuse may be designed (e.g., dimensioned, made with a specific material, and/or the like) to break once a current exceeds a temperature and/or or a current threshold. The temperature threshold may be associated with a melting temperature of the material used in the fuse, and be determined based on the current threshold. The current threshold may be a current associated with causing the fuse to break and/or melt.

In process block 248, the ceramic sheets may be stacked and pressed to form the body of the capacitor device. The stack of ceramic sheets may be formed by intercalating ceramic sheets from the first group (e.g., cathode layers) and ceramic sheets from the second group (e.g., anode layers), to form the capacitive layer of the capacitor. The fuse ceramic sheet may be placed under the capacitive layer of the stack, in a fuse layer of the capacitor structure 220 as illustrated in FIG. 11. The fuse layer may also include non-stenciled sheets to create a physical separation between the fuse ceramic sheet and the capacitive layer. In some embodiments, the fuse layer may have a thickness (e.g., the height 229 in FIG. 11) that is equal to the height of the capacitive layer. In some embodiments, the fuse layer may have a thickness that is approximately a quarter of the capacitive layer. The non-stenciled sheets may be used to generate the thickness.

In process block 249, metallization may be added to the body of the capacitor device to form terminations. In some embodiments, a first metallic termination may be formed to resistively couple the electrodes of the cathode layers to an external substrate (e.g., a printed circuit board), a second metallic termination may be formed to resistively couple the electrodes of the anode layers to the fuse of the fuse layer, and a third metallic termination may be formed to resistively couple the fuse of the fuse layer to the external substrate. The second metallic termination may be internal to the capacitor structure, and an insulation coating may be applied to prevent accidental shorting between the second metallic termination and an external substrate.

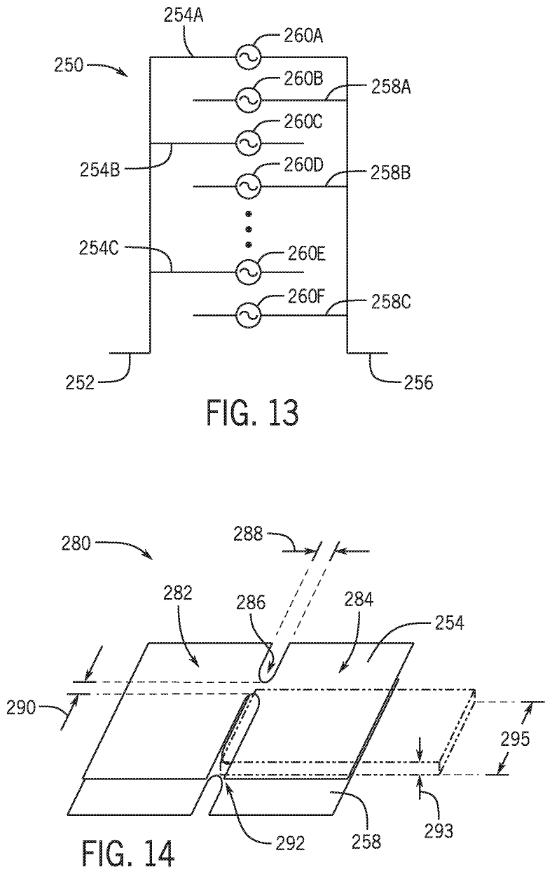

The capacitor structures discussed above may have a single fuse that, when broken, effectively removes a capacitor from a circuit including the capacitor. FIG. 13 illustrates a monolithic self-fused capacitor structure 250 that include multiple fuses and, thus, provide gradual failure that preserves some functionality. In the self-fused capacitor structure 250, when one of the multiple fuses break, only a portion of the capacitor is effectively removed from a circuit including the capacitor structure 250. The remaining portion of the capacitor structure 250 may provide capacitance and retain partial or total functionality. The capacitor structure 250 may be designed as an MLCC having a first terminal 252 resistively coupled to a first set of electrodes 254A-C. The capacitor structure 250 may have a second terminal 256 resistively coupled to a second set of electrodes 258A-C.

Each electrode 254A-C may be capacitively coupled to adjacent electrodes 258A-C, and the set of the capacitive couplings between electrodes 254A-C and 258A-C may jointly provide the capacitance of the capacitor structure 250. For example, electrode 258A forms a capacitive coupling with electrodes 254A and 254B in the illustration. As such, the capacitor structure 250 is formed by multiple capacitors between adjacent electrodes 254 and 258 arranged in parallel. Moreover, in the capacitor structure 250, each electrode 254A-C and 258A-C may have a fuse 260A-F. As illustrated in the diagram, fuses 260A, 260C, and 260E are placed with electrodes 254A, 254B, and 254C, respectively and fuses 260B, 260D, and 260F are placed with electrodes 258A, 258B, and 254C, respectively. Therefore, when a single fuse (e.g., fuse 260B) blows, only the electrodes placed with the fuse (e.g., electrode 258A) and the adjacent electrodes (e.g., electrodes 254A and 254B) may be affected. The remainder of the electrodes may remain functioning as a capacitor with reduced capacitance. In an MLCC having a hundred layers, a single blowout may affect 2 or 3 layers, and thus, the impact in the capacitance of the device may be under 5%. Other tolerance margins may be specified. Such variation may be within the tolerance margins of the capacitor device. As such, a capacitor that suffers a failure that generates a short between two adjacent electrodes may operate within the tolerance margins and the electrical device does not suffer any impact from such failure.

FIG. 14 illustrates a portion 280 of a capacitor having a pair of electrodes having a fuse. The diagram shows adjacent electrodes 254 and 258. The electrode 254 may have a first portion 282 and a second portion 284. The first portion 282 and the second portion 284 may be connected by a fuse link 286. The fuse link 286 may have a length 288 and width 290 that is substantially smaller than the length and width of the first portion 282 and the second portion 284. In some embodiments, the width 290 for the fuse link 286 may be specified to be smaller than 200 μm, smaller than 100 μm, smaller than 50 μm, smaller than 25 μm, or another width specification based on the melting temperature of the material and a nominal shorting current or voltage expected to cause a break of the fuse link 286. As such, when a failure that leads to a short between the first portion 282 or the second portion 284 and the electrode 258, the fuse link 286 may be subject to an increased power dissipation demand. As a result, the fuse link 286 may heat, exceed its melting temperature, and blow, cutting the resistive connection between the first portion 282 and the second portion 284. As a result, damages to the remainder of the capacitor due to the failure are mitigated. The portion 280 of the capacitor also has a fuse link 292 in the electrode 258. Fuse link 292 performs a similar function as fuse link 286.

In the diagram, electrode 258 may be separated from electrode 258 by a vertical distance 293. Note further that the fuse link 286 is horizontally separated from fuse link 292 by a horizontal distance 295. The horizontal distance 295 may provide a separation that prevents the heating and/or blowing of a fuse link 286 of electrode 254 from affecting (e.g., heating or causing a break) the fuse link 292 of an adjacent electrode 258, and vice-versa. This arrangement may prevent fuses from breaking when the short circuit is in an adjacent electrode, containing thus the damage due to a short circuit. More generally, embodiments in which fuses and/or fuse links are horizontally staggered may be used to improve the mitigation capacity of the self-fused capacitors described herein.

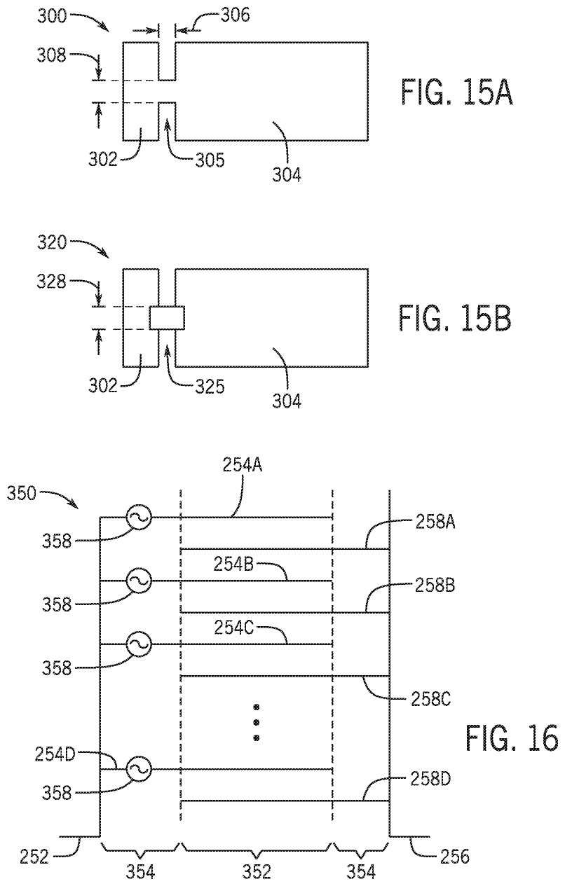

FIG. 15A illustrates a top view of an electrode layout 300 for an electrode-borne fuse in a ceramic layer. The electrode layout 300 may be used to form an electrode layer that has a fuse or fuse link. The electrode layout 300 may have a first portion 302 and a second portion 304 that may be linked by a fuse 305. As illustrated, the fuse may have a length 306 and a width 308. In the electrode layer 300, the conductive material employed for the portions 302 and 304 of the electrode may be formed from the same as the conductive material employed for the fuse 305. As such, the electrode layout 300 may be stenciled in a single step. The length 306 and width 308 of the fuse 305 may be determined based on a current threshold or a temperature threshold. In some embodiments, the width 308 for the fuse 305 may be specified to be smaller than 200 μm, smaller than 100 μm, smaller than 50 μm, smaller than 25 μm, or another width specification as discussed herein. The temperature threshold may be associated with the melting temperature of the conductive material. The current threshold may be a current associated with causing the fuse 305 to break and/or melt.

FIG. 15B illustrates a top view of a second electrode layout 320 for an electrode-borne fuse in a ceramic layer. The electrode layout 320 may be used to form an electrode layer that has a fuse or fuse link with a different conductive material. In the electrode layout 320, the first portion 302 and the second portion 304 may be resistively coupled by a fuse 325 that is produced with a second material. The fuse 325 may have a width 328 that may be determined based on a current threshold or temperature threshold. The temperature threshold may be associated with the melting temperature of the conductive material of the fuse 325. In some embodiments, the width 328 for the fuse 325 may be specified to be smaller than 200 μm, smaller than 100 μm, smaller than 50 μm, smaller than 25 μm, or another width specification as discussed herein. The current threshold may be a current associated with causing the fuse 325 to break and/or melt. As such, the second electrode layout 320 may be used for situations where the current or temperature threshold does not permit the convenience of using the conductive material of the electrodes.

As the fuse reaches high temperatures prior to blowing, the fuse may cause physical damage to physically neighboring portions of the capacitor, such as adjacent electrodes. FIG. 16 illustrates a monolithic self-fused capacitor structure 350 that include multiple fuses located in a region such that the physical damage from a fuse blowing does not affect active regions in the capacitor structure 350. As with the capacitor structure 250 of FIG. 13, the capacitor structure 350 may have a first terminal 252 resistively coupled to a first set of electrodes 254A-D and a second terminal 256 resistively coupled to a second set of electrodes 258A-D. Moreover, the capacitor structure 350 may have a capacitive region 352, the region where the capacitive couplings are formed, and terminal regions 354 in which the electrodes do not form capacitive coupling. Fuses 358A-D of capacitor structure 350 are located in the terminal regions 354 and physically separated from the capacitive region 352 to prevent the blowing of a fuse 358A-D from affecting adjacent electrodes in the capacitive region 352.

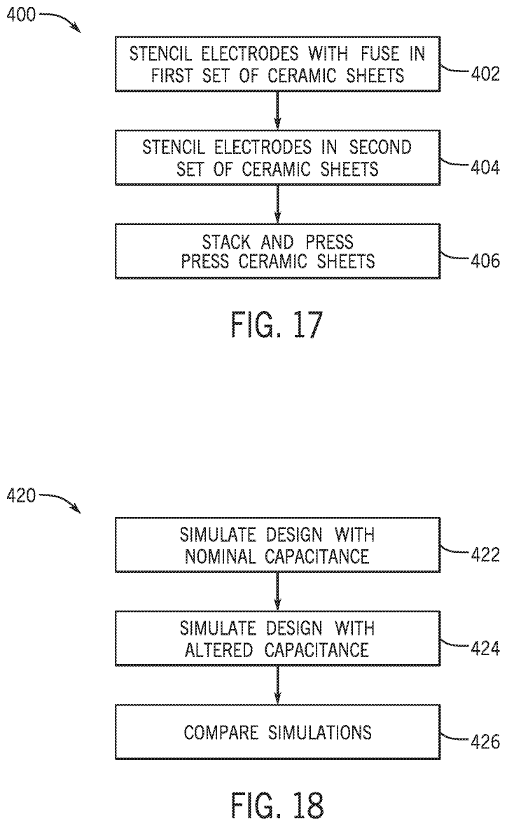

FIG. 17 is a flow chart of a method 400 that may be used to produce a monolithic self-fused capacitor, such as the capacitor structures 250 and 350 of FIGS. 13 and 16, respectively, illustrated above. In process block 402, a first group of ceramic sheets may be stenciled with a conductive material to create electrode layers of a first group (e.g., cathode layers) with a fuse. Electrode layouts 300 and 320 of FIGS. 15A and 15B, respectively, may be used to obtain the electrode-borne fuses. In process block 404, a second group of ceramic sheets may be stenciled with the conductive material to create electrode layers of a second group (e.g., anode layers). The electrode layers of the second group may include fuses to form capacitors in which every electrode has a fuse (e.g., such as in the capacitor structure 250).

The electrodes in process blocks 402 and 404 may be stenciled using nickel or a nickel oxide, or any other suitable material to produce MLCC layers. Moreover, the fuse in process block 402 or 404 may be stenciled using an alloy that includes copper, zinc, lead, silver, nickel, aluminum, copper oxide, zinc oxide, lead oxide, silver oxide, nickel oxide, aluminum oxide, and/or the like. The stenciling of fuse and of the electrodes may include deposition, direct binding, and/or trimming. The fuse may be designed (e.g., dimensioned, made with a specific material, and/or the like) to break once a current exceeds a temperature or a current threshold. The temperature threshold may be associated with a melting temperature of the material used in the fuse, and be determined based on the current threshold. The current threshold may be a current associated with causing the fuse to break and/or melt. In process block 406, the ceramic sheets may be stacked by intercalating ceramic sheets from the first set and from the second set of ceramic sheets. The stack of ceramic sheets may pressed to form a body of the capacitor. Terminations may be added to the body of the capacitor through metallization of the ends of the capacitor.

In the above discussion, the fuses may have a current threshold for breaking or blowing. The current threshold may be a part of a specification for the capacitor device, and fuse characteristics may be calculated based on the current threshold. Specifically, the fuse may have a cross-section determined by the thickness of the stenciled fuse and a width of the stenciled fuse. Based on the cross-section area and the specific resistivity of the conductive material of the fuse layer, the power dissipated by the capacitor may be calculated as function of the current. Using these parameters and functions, the fuse characteristics, which include fuse thickness, fuse width, fuse material resistivity, and fuse material melting point, may be calculated from the threshold current.

In monolithic embodiments, care should be taken with respect to the temperatures that may be reached by the fuse. A fuse that has a very low melting temperature may break prematurely during regular operations due to environmental temperature. A fuse that has a melting temperature that is high enough to damage the ceramic substrate of the capacitor structures may cause further deterioration to the capacitor structure before breaking. In some embodiments, the conductive material used to form the fuse may have a melting temperature between 750° C. and 1400° C. It should be noted that other melting temperatures may be chosen in view of the temperature characteristics of the substrate of the capacitor.

As discussed above, embodiments of the present application include capacitors that have the property to mitigate its failure. For example, a self-fused capacitor may have a nominal capacitance as well as a series of diminished capacitances associated with a degree of deterioration. For example, a capacitor structure may have a nominal capacitance of 10 μF and an altered capacitance of 9 μf when a failure causes a short in 10% of the electrodes. Such information may be provided as an empirical table or curve. Reliability of electrical devices using such capacitors may be further enhanced by the implementation of the failure mitigation characteristics in the design. The flowchart in FIG. 18 illustrates a method 420 to incorporate the disclosed failure prevention or mitigation characteristics in capacitor design. In process block 422, the electrical device may be designed and simulated using the nominal capacitance. In process block 424, the electrical device may be simulated using one or more altered capacitances based on a specification of the self-fused capacitor. In process block 426, the simulations may be compared. The comparison may, along with data related to failure rate estimates and tolerance estimates, be used to obtain estimates related to failure rate and/or lifecycle estimates of an electronic device. The use of method 420 may, thus, supply information related to the reliability of the capacitors and/or the electronic devices.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

1. A multilayer ceramic capacitor (MLCC) comprising:
a first plurality of ceramic layers, wherein each ceramic layer of the first plurality of ceramic layers comprises a respective first electrode that comprises:
a first portion comprising a first conductive material;
a second portion separated by a first distance from the first portion and comprising the first conductive material; and
a fuse link comprising a second conductive material and configured to create a first resistance between the first portion to the second portion; and
a second plurality of ceramic layers, wherein each ceramic layer of the second plurality of ceramic layers comprises a respective second electrode that forms a respective capacitive coupling with the respective first electrode of an adjacent ceramic layer of the first plurality of ceramic layers.

2. The MLCC of claim 1, wherein each second electrode of each ceramic layer of the second plurality of ceramic layers comprises:
a third portion comprising the first conductive material;
a fourth portion separated by the first distance from the second portion and comprising the first conductive material; and
a second fuse link comprising the second conductive material and configured to resistively couple the third portion and the fourth portion.

3. The MLCC of claim 1, comprising a capacitive region that comprises each respective capacitive coupling, wherein each respective fuse link of each respective first electrode of the first plurality of ceramic layers is outside the capacitive region.

4. The MLCC of claim 1, wherein the second conductive material comprises a melting point, and wherein the first resistance is configured to cause the fuse link of a first electrode to reach a temperature that exceeds the melting point when there is a short circuit between the first electrode and an adjacent second electrode.

5. The MLCC of claim 4, wherein the melting point is between 750 degrees Celsius and 1400 degrees Celsius.

6. The MLCC of claim 4, wherein the fuse link comprises a height, a width, and a thickness that determines the first resistance.

7. The MLCC of claim 1, wherein the first conductive material and the second conductive material are the same.

8. The MLCC of claim 1, comprising a first capacitance when no fuse link of the MLCC is blown and a second capacitance when a single fuse link of the MLCC is blown, wherein the second capacitance is within 5% of the first capacitance.

9. A method to produce a capacitor, comprising:
applying a first conductive material to a first ceramic sheet in a first region of the first ceramic sheet to form a first portion of an anode;
applying the first conductive material to the first ceramic sheet in a second region of the first ceramic sheet to form a second portion of the anode, wherein the second portion of the anode is separated from the first portion of the anode; and
applying a second conductive material to the first ceramic sheet in a third region of the first ceramic sheet to form a fuse link configured to provide a resistive coupling between the first portion of the anode and the second portion of the anode;
applying the first conductive material to a second ceramic sheet to form a cathode; and
stacking the first ceramic sheet and the second ceramic sheet to form a capacitive coupling between the anode of the first ceramic sheet and the cathode of the second ceramic sheet.

10. The method of claim 9, wherein applying the first conductive material to the first ceramic sheet comprises stenciling nickel, or nickel oxide, or any combination thereof, over the first ceramic sheet.

11. The method of claim 9, wherein applying the second conductive material comprises binding or depositing a metal alloy that comprises copper, zinc, lead, copper, silver, aluminum, a copper oxide, a zinc oxide, a lead oxide, a silver oxide, or an aluminum oxide, or any combination thereof, to the second ceramic sheet.

12. The method of claim 9, wherein the first conductive material and the second conductive material are the same.

13. A multilayer capacitor device comprising:
a first plurality of electrode layers, each layer comprising a respective first electrode resistively coupled to a first termination connector;
a second plurality of electrode layers, each layer comprising a respective second electrode resistively coupled to a second termination connector, wherein each respective first electrode of the first plurality of electrode layers is capacitively coupled to the respective second electrode of a respective adjacent electrode layer of the second plurality of electrode layers; and
a fuse layer comprising a fuse resistively coupled to the first termination connector and resistively coupled to a first termination of the multilayer capacitor device, wherein the fuse is configured to:
provide a resistive coupling between the first termination connector and the first termination; and
break the resistive coupling when the fuse receives a first current above or equal to a threshold current.

14. The multilayer capacitor device of claim 13, wherein the fuse comprises silver, tin, zinc, lead, copper, aluminum, nickel, or any combination thereof.

15. The multilayer capacitor device of claim 13, wherein the fuse layer comprises a ceramic substrate.

16. The multilayer capacitor device of claim 15, wherein the ceramic substrate comprises aluminum nitrate, aluminum oxide, barium titanate, or any combination thereof.

17. The multilayer capacitor device of claim 13, comprising a monolithic structure, wherein the monolithic structure comprises the first plurality of electrode layers, the second plurality of electrode layers, and the fuse layer.

18. The multilayer capacitor device of claim 13, comprising a first monolithic structure soldered to a second monolithic structure, wherein the first monolithic structure comprises the first plurality of electrode layers and the second plurality of electrode layers, and wherein the second monolithic structure comprises the fuse layer.

19. The multilayer capacitor device of claim 13, wherein the fuse comprises a metal alloy comprising a melting point between 750 degrees Celsius and 1400 degrees Celsius, and wherein the fuse is configured to reach the melting point when the first current exceeds the threshold current.

20. The multilayer capacitor device of claim 13, wherein the fuse layer comprises a thickness between 10 μm and 200 μm.
